(19) United States
(12) Patent Application Publication
(10) Pub. No.: US 2013/0073437 A1
(43) Pub. Date: Mar. 21, 2013

(54) PREVIEWING PROJECTED BALANCE IMPACTS

(71) Applicants: Djiao Mei Siauw, Redwood City, CA (US); Robert Zwiebach, San Mateo, CA (US); Neil Ramsay, Madrid (ES)

(72) Inventors: Djiao Mei Siauw, Redwood City, CA (US); Robert Zwiebach, San Mateo, CA (US); Neil Ramsay, Madrid (ES)

(73) Assignee: Oracle International Corporation, Redwood Shores, CA (US)

(21) Appl. No.: 13/460,127

(22) Filed: Apr. 30, 2012

Related U.S. Application Data
(60) Provisional application No. 61/536,971, filed on Sep. 20, 2011.

(51) Int. Cl. G06Q 40/00

(52) U.S. Cl. 705/30

(57) ABSTRACT

A method of previewing projected balance impacts in an Enterprise Financial Accounting System is presented. The method may include receiving journal entries that have not been posted to an accounting ledger; displaying the journal entries in a journal portlet; receiving a selection of a first journal entry with a first amount; determining a first ledger that is associated with the first amount; receiving a start date and a beginning balance of the first ledger on the start date; receiving an activity total including a sum of journal entries posted to the first ledger between the start date and a current date; determining a projected balance representing a combination of the beginning balance, the activity total, and the first amount; and displaying a projected balances portlet together with the journal portlet, that includes the beginning balance, the activity total, the first amount, and the projected balance.

### CROSS-REFERENCES TO RELATED APPLICATIONS

The present application claims benefit under 35 USC 119(e) of U.S. Provisional Application No. 61/536,971, filed on Sep. 20, 2011 by Ramsay et al, and entitled “Mechanism To View Embedded Analytics (Financial Impacts Of A Particular Transaction That Is About To Be Entered) In The Transactional Flow Pages,” of which the entire disclosure is incorporated herein by reference for all purposes.

### BACKGROUND

Enterprise resource planning (ERP) systems integrate internal and external management information across an entire organization. ERP systems may embrace finance/accounting, manufacturing, sales and service, customer relationship management, human resource management, and the like. ERP systems may be used to automate activities between these different resources within an integrated software application. One purpose may be to facilitate the flow of information between business functions across boundaries of an organization, and to manage the connections between outside stakeholders and internal resources.

Each resource within an ERP system may include many subsystems to manage various resources. For example, a finance/accounting application in an ERP system may be distributed among many different departments within an organization, and may be used to manage many different types of financial accounts. The finance/accounting application may include various traditional accounting features, such as various ledgers, subledgers, journals, and a general ledger. Each of these accounting features is typically implemented with their own interfaces and applications within the ERP. Therefore, improvements in the art may be desirable.

### BRIEF SUMMARY

In one embodiment, a method of previewing projected balance impacts in an Enterprise Financial Accounting System is presented. The method may include receiving one or more journal entries that have not been posted to an accounting ledger and displaying the one or more journal entries in a journal portlet. The method may further include receiving a selection of a first journal entry from the one or more journal entries. In one embodiment, the first journal entry may comprise a first amount. The method may also include determining a first ledger that is associated with the first amount. The method may additionally include receiving a start date, and receiving a beginning balance representing a balance of the first ledger on the start date. The method may further include receiving an activity total comprising a sum of journal entries posted to the first ledger between the start date and a current date, and determining a projected balance representing a combination of the beginning balance, the activity total, and the first amount. The method may also include displaying a projected balances portlet together with the journal portlet, wherein the projected balances portlet may include the beginning balance, the activity total, the first amount, and the projected balance.

In one embodiment, the method may also include receiving an indication that the first amount should be posted to the first ledger; determining that posting the first amount to the first ledger requires an authorization; sending a request to authorize posting the first amount to the first ledger; receiving the authorization to post the first amount to the first ledger, wherein the authorization is based at least in part on the projected balance; and automatically posting the first amount to the first ledger in response to receiving the authorization. In another embodiment, the method may further include displaying an indication to a user that posting the first amount to the first ledger requires the authorization. The method may additionally include determining that the first journal entry further comprises a second amount; determining a second ledger that is associated with the second amount; receiving a second beginning balance representing a balance of the second ledger on the start date; receiving a second activity total comprising a sum of journal entries posted to the second ledger between the start date and the current date; determining a second projected balance representing a combination of the second beginning balance, the second activity total, and the second amount; and displaying, in the projected balances portlet together with the beginning balance, the activity total, the first amount, and the projected balance: an identifier of the first ledger, an identifier of the second ledger, the second beginning balance, the second activity total, the second amount, and the second projected balance.

In one embodiment, the method may further include receiving a selection of a second journal entry from the one or more journal entries, where the second journal entry may comprise a second amount; determining that the second amount of the second journal entry is associated with the first ledger; and displaying in the projected balances portlet the second amount, where the combination representing the projected balance may further include the second amount. In another embodiment, the method may also include receiving a selection of a second journal entry from the one or more journal entries, where the second journal entry may comprise a second amount; determining that the second amount is associated with a second ledger; receiving a second beginning balance representing a balance of the second ledger on the start date; receiving a second activity total comprising a sum of journal entries posted to the second ledger between the start date and the current date; determining a second projected balance representing a combination of the second beginning balance, the second activity total, and the second amount; and displaying, in the projected balances portlet together with the beginning balance, the activity total, the first amount, and the projected balance: an identifier of the first ledger, an identifier of the second ledger, the second beginning balance, the second activity total, the second amount, and the second projected balance.

In one embodiment, the start date may be the beginning of an accounting period. In another embodiment, displaying the projected balances portlet occurs automatically in response to the selection of the first journal entry. In yet another embodiment, the combination of the beginning balance, the activity total, and the first amount may comprise an arithmetic sum of the beginning balance, the activity total, and the first amount. In yet another embodiment, the first amount may comprise a first currency and the second amount may comprise a second currency, and the projected balance portlet may convert the first amount into the second currency. In one embodiment, the request to authorize posting the first amount to the first ledger may be part of a work flow; and posting the first amount to the first ledger may be part of the same workflow.

In another embodiment, a computer-readable memory is presented the memory may have stored thereon a sequence of instructions which, when executed by one or more processors, causes the one or more processors to preview projected balance impacts in an Enterprise Financial Accounting System by receiving one or more journal entries that have not been posted to an accounting ledger, and displaying the one or more journal entries in a journal portlet. The one or more processors may further operate by receiving a selection of a first journal entry from the one or more journal entries, where the first journal entry may include a first amount, and determining a first ledger that is associated with the first amount. The one or more processors may also operate by receiving a start date and receiving a beginning balance representing a balance of the first ledger on the start date. The instructions may additionally cause the one or more processors to operate by receiving an activity total including a sum of journal entries posted to the first ledger between the start date and a current date, and determining a projected balance representing a combination of the beginning balance, the activity total, and the first amount. The instructions may also cause the one or more processors to operate by displaying a projected balances portlet together with the journal portlet, where the projected balances portlet may include the first amount, and the projected balance.

In yet another embodiment, a system including one or more processors, and a memory is presented. The memory may be communicatively coupled with and readable by the one or more processors and have stored therein a sequence of instructions which, when executed by the one or more processors, cause the one or more processors to preview projected balance impacts in an Enterprise Financial Accounting System by receiving one or more journal entries that have not been posted to an accounting ledger; and displaying the one or more journal entries in a journal portlet. The instructions may also cause the one or more processors to operate by receiving a selection of a first journal entry from the one or more journal entries, where the first journal entry may include a first amount, and determining a first ledger that is associated with the first amount. The instructions may additionally cause the one or more processors to operate by receiving a start date and receiving a beginning balance representing a balance of the first ledger on the start date. The instructions may further cause the one or more processors to operate by receiving an activity total comprising a sum of journal entries posted to the first ledger between the start date and a current date, and determining a projected balance representing a combination of the beginning balance, the activity total, and the first amount. The instructions may also cause the one or more processors to operate by displaying a projected balances portlet together with the journal portlet, where the projected balances portlet may include the first amount, and the projected balance.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram illustrating components of an exemplary operating environment in which various embodiments of the present invention may be implemented.

FIG. 2 illustrates a block diagram illustrating an exemplary computer system in which embodiments of the present invention may be implemented.

FIG. 3 illustrates a diagram of a journal being posted to one or more account ledgers, according to one embodiment.

FIG. 4 illustrates a workflow diagram for accountants or data entry clerks entering transactions into an accounting journal, according to one embodiment.

FIG. 5 illustrates a workflow diagram of a method for reviewing journal entries, according to one embodiment.

FIG. 6 illustrates a flowchart of a method of validating accounting journal entries in an Enterprise Financial Accounting System, according to one embodiment.

FIG. 7 illustrates a flowchart of a method for automatically posting a journal entry requiring review, according to one embodiment.

FIG. 8 illustrates a flowchart of a method for displaying the projected balances for multiple transactions in a single journal entry, according to one embodiment.

FIG. 9 illustrates a flowchart of a method for displaying projected balances of transactions in different journal entries, according to one embodiment.

FIG. 10 illustrates a flowchart of a method for displaying projected balances of transactions in different journal entries that are associated with different account ledgers, according to one embodiment.

FIG. 11 illustrates a task flow for using a projected balance portlet to verify a journal entry, according to one embodiment.

FIG. 12 illustrates an interface for displaying projected balances, according to one embodiment.

FIG. 13 illustrates an interface and displaying projected balances, according to another embodiment.

FIG. 14 illustrates a block diagram of an exemplary system for implementing a journal entry and preview interface, according to one embodiment.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “ machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Described herein, are embodiments for validating and/or previewing account journal entries in an Enterprise Financial Accounting System. A journal portlet may be provided wherein a user can edit and/or enter journal entries for a particular journal. Journal entries may include multiple transactions that may be posted to multiple accounts. In one embodiment, the user may select one or more journal entries comprising one or more transactions, and subsequently see the effect that posting the selected journal entries will have on accounting ledgers that are associated with the journal entries. A projected balance for each of the account ledgers may be displayed in a separate projected balance portlet that is displayed at the same time as the journal portlet. An accounting period may be selected, such as the period-to-date, and the projected balances portlet may be configured to display for each account, a beginning balance, activity since the start of the accounting period, any amounts from the selected journal entries, and a balance if the selected journal entries were to be posted.

Additionally, after reviewing the projected balances, it may be determined that the journal entries in the journal portlet may be posted to their respective ledgers. In order to post transactions to some ledgers, an authorization may be required from the manager. The user entering transactions into the journal portlet may provide an input indicating an intent to post transactions to the ledgers, some embodiments may automatically determine that an authorization is required, and send an indication to a manager requesting such authorization. The manager may authorize the journal entries after reviewing the projected balances and allow them be posted to the ledgers. Alternatively, the manager may reject the journal entries, and send them back to the user for deletion or correction.

Prior to this disclosure, entering transactions into an accounting journal was a process that was susceptible to many errors. Accountants often enter transactions into journals when they receive an invoice, bill, purchasing order, requisition, and/or like. In many cases this involved manually transcribing data from a document into an accounting application. Because of the tedious and often repetitive nature of the data entry process, transcription errors and typos often found their way into accounting journals. The only way to detect these errors was to manually examine the data as it is being entered. Because data entered into accounting journals were not reflected in the accounting ledgers with which the transactions were associated, obvious errors affecting the balance of these accounting journals often went undetected.

In order to determine how data entered into an accounting journal affects the balance in an associated accounting ledger, the journal entries had to first be posted to the accounting ledger. This involves importing the data from the transactions in the accounting journal into the accounting ledger as debits and credits, then recalculating the balance of the accounting ledger. However, because posting journal entries affects the balance of the accounting ledgers, and because the accounting ledgers are used to produce legally required financial statements, posting journal entries often requires authorization from the supervisor, such as an accounting manager. In existing software systems, the approval workflow is separate from the accounting software itself. Therefore, in order to post a journal entry, the journal entry must be approved through a first workflow, and then posted through a second workflow. This required two separate transactions by an accountant.

As used herein, the term “journal entry and preview interface” may be used to describe any user interface that provides for editing and updating a journal while providing real-time projected balances generated by any changes to the journal. The journal entry and preview interface may be textual, and indications may be textual descriptions of the various ledgers and balances. In another embodiment, the journal entry and preview interface may be graphical, and indications may be in the form of graphical icons that may be selected by an input device. The journal entry and preview interface may be provided on many possible output devices. In one embodiment, the journal entry and preview interface may be provided on a computer screen, while other embodiments may use the screen on a mobile phone, a laptop computer, a projector, a tablet computer, a PDA, and/or the like.

In some embodiments, the journal entry and preview interface may provide both a summary and detailed view of the status information for various journals and ledgers. A summary view may cut across a broad set of information at an overview level. It may show the status of selected journal entries and the associated account ledgers for a selected accounting period. Status changes may be effected and seen across the various ledgers from within the journal entry and preview interface with a single request. At the same time, a user may drill down into the status details of a particular journal entry to more closely review the effect of each individual component of a transaction.

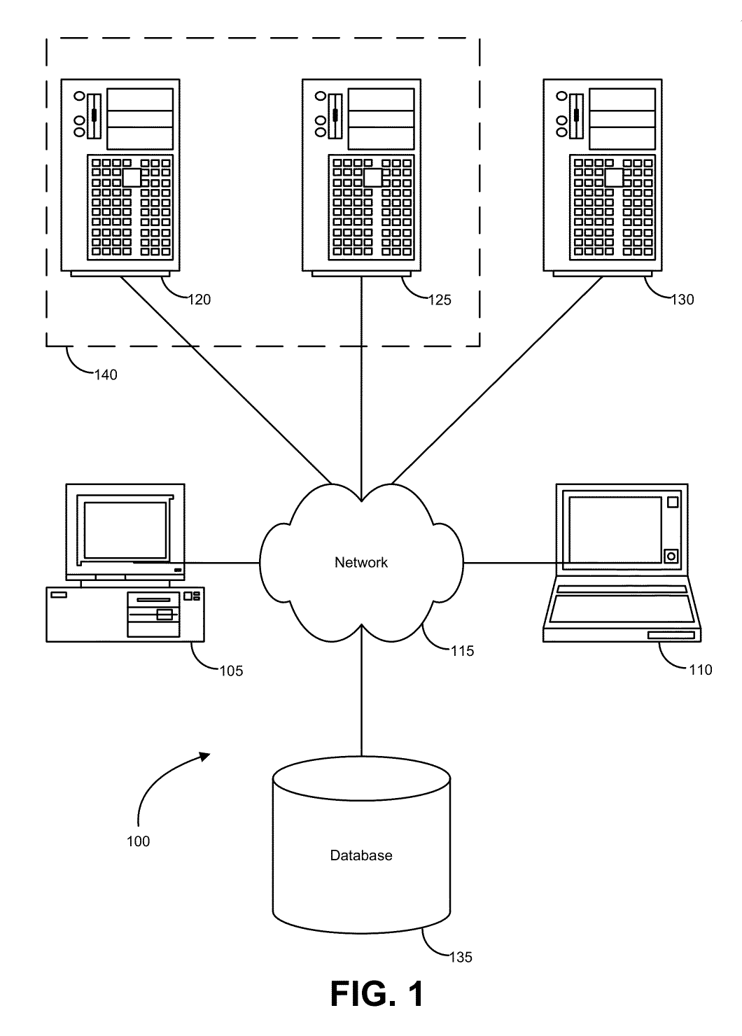

Each of the embodiments disclosed herein may be implemented in a computer system. FIG. 1 is a block diagram illustrating components of an exemplary operating environment in which various embodiments of the present invention may be implemented. The system 100 can include one or more user computers 105, 110, which may be used to operate a client, whether a dedicated application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) may also be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

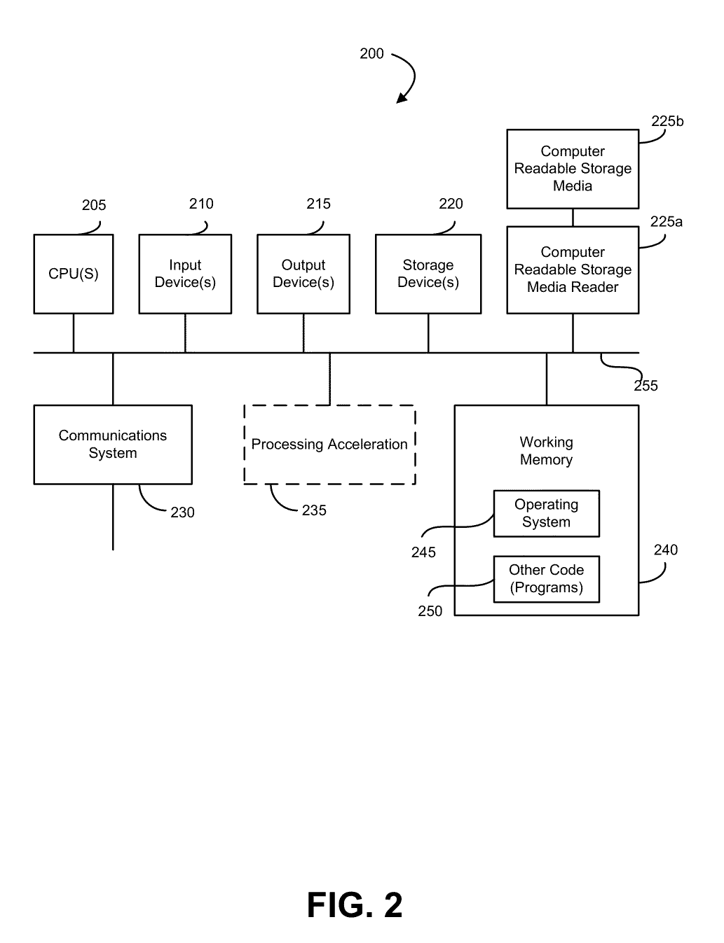

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

The following methods may be implemented by a computer system, such as computer system 200 in FIG. 2. Each step of these methods may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

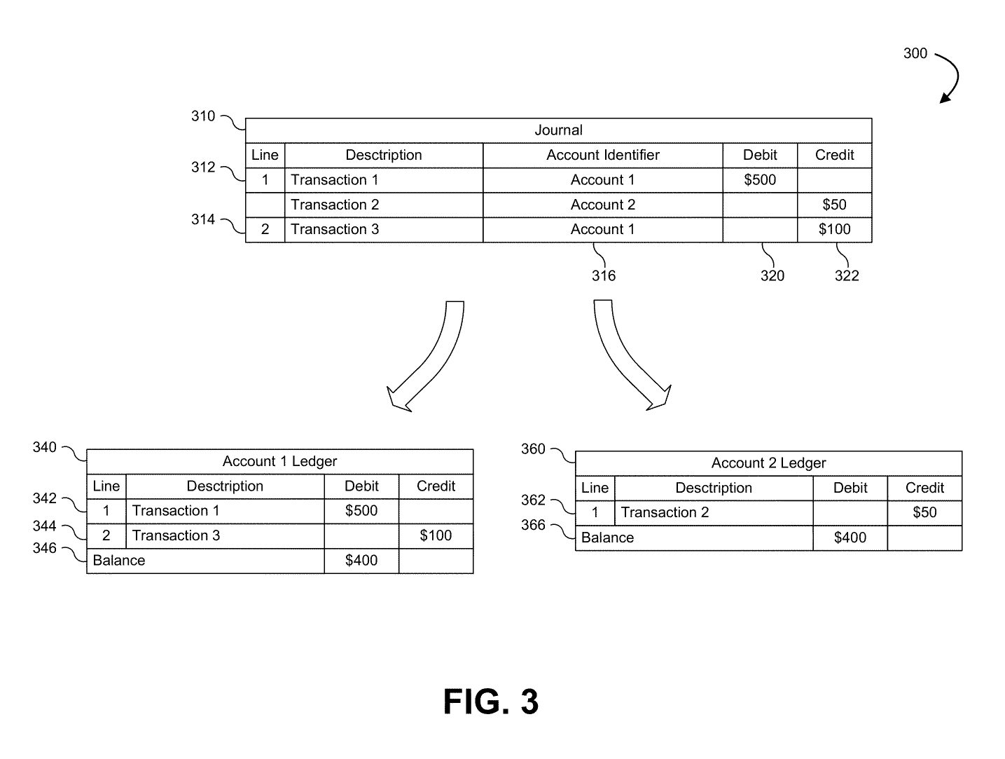

FIG. 3 illustrates a diagram 300 of a journal 310 being posted to one or more account ledgers, according to one embodiment. Journal 310 may be designed to receive transactions for a particular department. For example, journal 310 may be a journal for an accounts payable department. In this case, the transactions received may correspond to debts owed by the organization. Typically, transactions are recorded from a source document, such as an invoice, by an accountant or data entry clerk. Each journal entry may have one or more components, and each component, or transaction, may debit or credit a different account ledger. For example, in journal 310, journal entry 312 includes two components labeled transaction 1 and transaction 2. Transaction 1 is associated with account 1 and a debit of $500. Transaction 2 is associated with Account 2 and a credit of $50. In contrast, journal entry 314 has only a single component labeled transaction 3 that is associated with account 1 and a credit of $100.

After journal entry 312 and journal entry 314 have been entered into journal 310, the accountant or data entry clerk may desire to post various transactions to their respective account ledgers. In one embodiment, journal entries may be posted one at a time by selecting them individually. In another embodiment, a batch of journal entries may be posted at once by selecting a group or choosing to post the entire journal in a single operation.

Ledger 340 records transactions for account 1. After posting journal entries from journal 310, transaction 342 and transaction 344 with a debit of $500 and a credit of $100 respectively are posted to ledger 340. After posting, the balance 346 of ledger 340 is recalculated as a debit of $500. Similarly, ledger 360 may receive transaction 362 with a credit of $50. After posting, balance 366 of ledger 360 may be recalculated as a credit of $50. Although in this example ledger 340 and ledger 360 were empty prior to the posting of journal 310, it will be understood that each ledger may have had a previous balance. In this case, the balances of each ledger would reflect the change in the existing balance due to the posted transactions.

Note that in this example of FIG. 3, the data entry clerk or accountant entering data into journal 310 may not know the effect that each entry will have on the corresponding accounts once they are posted. For instance, the data entry clerk entering journal entry 312 may not know that posting this journal entry will result in a balance of $400 in the debit column of the account 1 ledger 340. Thus, any data entry error that would only be apparent once posted would not be visible or easily detectable to the person making the original journal entry, unless a projected balance portlet were used in the interface.

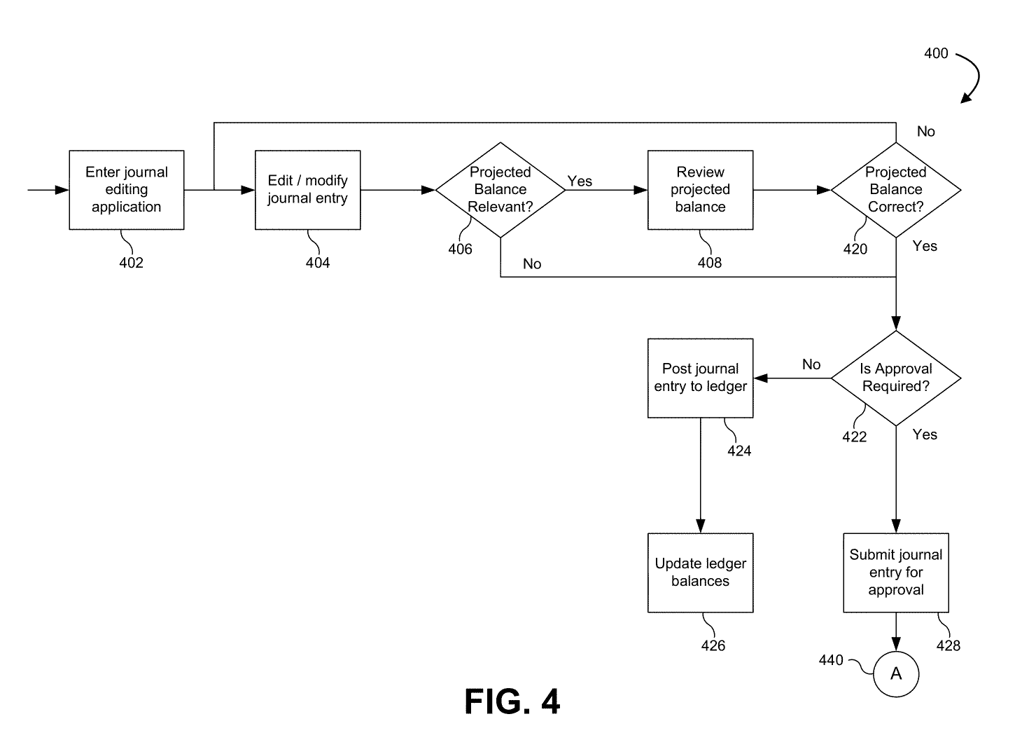

FIG. 4 illustrates a workflow diagram 400 for accountants or data entry clerks entering transactions into an accounting journal, according to one embodiment. Here, the journal entry and preview interface may be configured to display a projected balance for each transaction in a journal entry before it is posted. Thus, a data entry clerk or accountant would be able to detect errors and/or see results of journal transactions before they are posted to the account ledgers. First, the accountant may launch a journal editing application (402). The journal editing application may include the journal entry and preview interface. Next, the journal entry and preview interface may accept a new journal entry comprised of one or more transactions, each transaction associated with account ledger (404). Alternatively, the journal entry and preview interface may accept modifications to an existing journal entry.

It may next be determined whether the projected balance is relevant (406). In one embodiment, the user may determine whether the account ledgers to which journal transactions will be posted are of a type for which the balance should be checked. Some accounts may be of greater importance than others. More important accounts could have a relevant projected balance, whereas less important accounts may not. In another embodiment, the transactions in the journal entry themselves may be below a threshold value, and therefore be determined not to have relevant projected balances. For example, journal entries totaling more than $500 may require displaying a projected balance. In another embodiment, transactions that appear to include a typo may require reviewing the projected balance. In yet another embodiment, the experience of the user may determine whether a projected balance should be displayed. For example, a user with less than one year experience may be deemed more likely to be the source of data entry errors, and thus require projected balance review.

The projected balance, if deemed relevant, may be displayed and reviewed in a projected balance portlet (408). Displaying and reviewing the projected balance may take on many forms and various embodiments. For example, the projected balance could appear in a separate window within the journal entry and preview interface. The projected balance could appear in a pop-up window that may, or may not be modal. The projected balance may appear in a notification that requires user confirmation to continue. Specific embodiments may contain particular types of displays in which the projected balance can be reviewed, and will be discussed further later in this disclosure.

After display, it may be determined whether the projected balance is correct (420). If an error is detected in the projected balance, the journal entry and preview interface may allow for additional changes to be made to the journal entry before it is posted (404). If the projected balance is correct, it may then be determined whether approval is required for the journal entry to be posted (422). In the same way that a projected balance is determined to be relevant, the determination as to whether posting the journal entry requires approval may take into account the total value of the journal entry, the accounts which will be posted, and/or the history and experience of the user making the journal entry. If no approval is required, the transactions within the journal entry are posted to their respective account ledgers (424). After posting, the balances of each account ledger may be updated to reflect current balance after posting.

If approval is required to post the journal entry, the journal entry may be submitted for approval (428). In one embodiment, the entire journal entry may require approval, whereas in another embodiment only individual transactions within a journal entry may require approval. For example, a journal entry comprised of debits to the first account and a second account may post the transactions the first account, while requiring approval prior to posting the transaction to the second account. In another embodiment, if one transaction in a journal entry requires approval, then the entire journal entry may require approval.

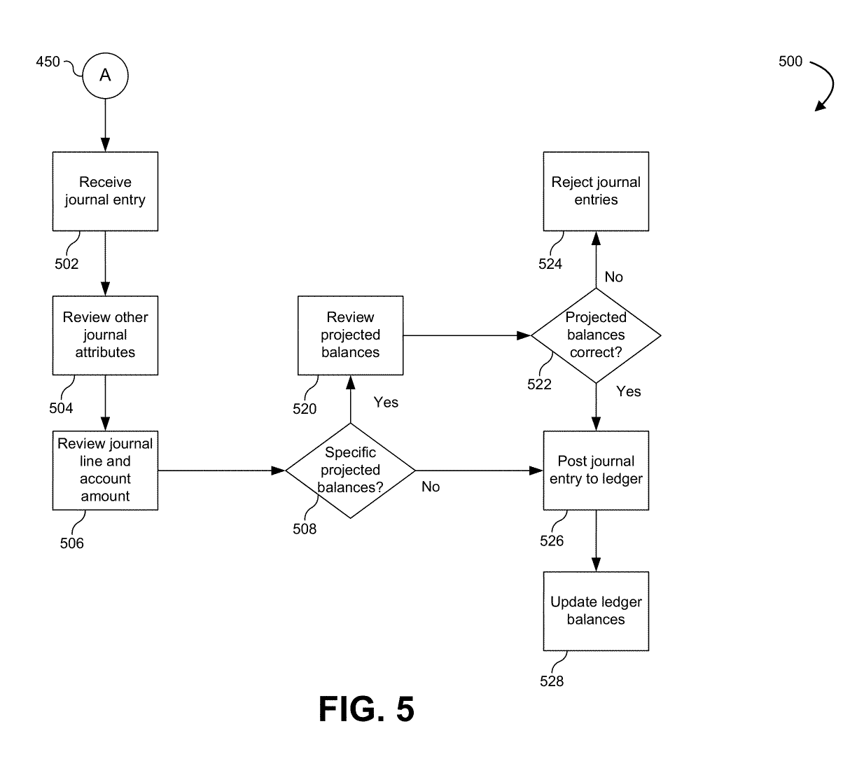

FIG. 5 illustrates a workflow diagram 500 of a method for reviewing journal entries, according to one embodiment. Workflow diagram 500 may be a continuation from workflow diagram 400 beginning at the indication marked with an “A” (440). A supervisor, manager, accountant, auditor, and/or the like, may receive a journal entry to be posted for review (502). In one embodiment, a batch of journal entries may be reviewed at once according to scheduled intervals, such as daily. In another embodiment, the user performing the review may be notified each time a journal entry is marked for posting that requires review.

Journal entries may include a number of different fields that may be reviewed other than the balance. These may include the accounts which transactions we posted, source documents, dates, and/or other transactional information. These other journal attributes may be reviewed as part of the review process (504). Most commonly, however, the reviewer will be required to review the journal line and account amounts for each transaction (506). Just as it was important to review the projected balances during the original data entry step, it may be important for the reviewer to see the projected balances for each transaction prior to approving the transactions for posting. Therefore, it may be determined, either by the reviewer or automatically, that specific projected balances for specific transactions may be relevant or required (508). Again, it may be determined whether projected balances should be displayed based on transaction amounts, account ledgers affected, and/or characteristics or history of the person or process entering the data. If it is determined that the projected balances do not need to be reviewed, the journal entries may be posted to the account ledgers (526), and ledger balances may be updated (528).

If it is determined that the projected balances should be displayed for the reviewer, these valves may be displayed in the journal entry and preview interface (520). This display may be similar to the projected balances displayed when the journal entries were originally created. In another embodiment, projected balances displayed for reviewer may contain more information than was displayed when the journal entries were originally created. For example, the projected balances display may also provide information relevant to a reviewer, such as error rates of a user creating the journal entries. The reviewer may determine whether the projected balances are correct (522). If they are correct, the journal entries may be posted (526). Alternatively, if projected balances are not correct, the reviewer may reject the journal entries (524). In one embodiment, the reviewer may reject portions of the journal entry while accepting other portions for posting. In another embodiment, if any part of a journal entry is rejected, the entire journal entry may be rejected. Rejected journal entries may be sent back to the original creator of the journal entry, along with a notification explaining why the journal entry was rejected. The notification may include the projected balances.

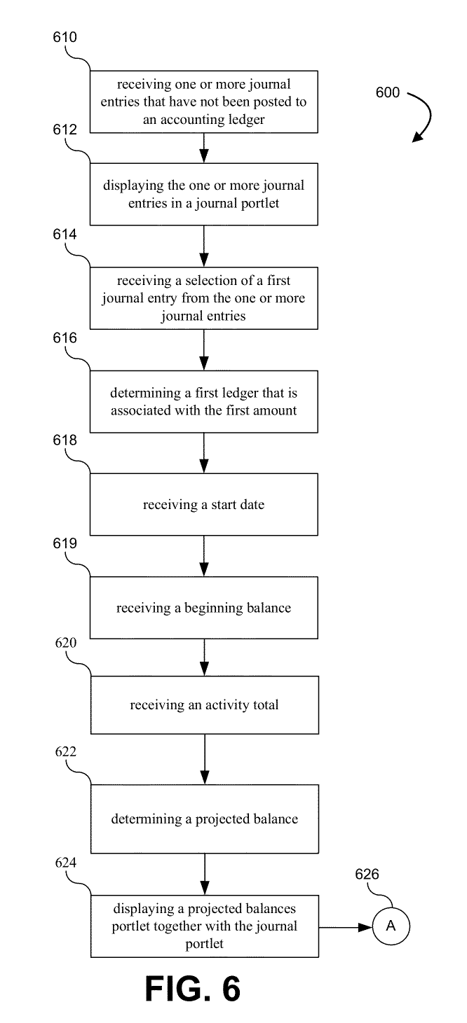

FIG. 6 illustrates a flowchart 600 of a method of validating accounting journal entries in an Enterprise Financial Accounting System, according to one embodiment. The method may include receiving one or more journal entries that have not been posted to an accounting ledger (610). In one embodiment, the journal entries may be received from the account validation interface, in real time as they are entered by a user. In another embodiment, the journal entries may be received from another accounting application. The journal entries may be received as a batch for a reviewer, or they displayed one at a time for individual review. The journal entries may also include entries that were previously rejected by reviewer that have undergone modifications in response to an incorrect projected balance.

The method may also include displaying the one or more journal entries in a journal portlet (612). The journal portlet may be a window within the journal entry and preview interface. The journal portlet may also be displayed as a standalone application or applet in a web browser. The journal entries may be displayed on a display device of a computer system, such as the output devices 215 of computer system 200 in FIG. 2. The journal portlet may also be displayed as an app on a smartphone or tablet computer. The journal portlet may display the journal entries in real time as they are entered, or later to facilitate review.

The method may additionally include receiving a selection of a first journal entry from the one or more journal entries (614). The selection may be made using an input computer system, such as the input devices 210 the computer system 200. In one embodiment, the selection may include a single journal entry. In another embodiment, the selection may include multiple journal entries. In yet another embodiment, the selection may include individual transactions within one or more journal entries. The selection may be manually provided by a user, or the selection may be made automatically by a computer system. Selections may be chosen automatically based on the criteria for review by a supervisor, such as exceeding a threshold amount. In one embodiment, the first journal entry comprises a first amount. This amount may be associated with a single transaction, and may be a debit or credit to a particular account. For example, the first amount may be an amount to be debited to an accounts payable ledger.

The method may further include determining a first ledger that is associated with the first amount (616). In one embodiment, the first ledger may be included as a part of the journal entry. For example, an accountant recording an invoice from a supplier could record any accounts to be credited or debited from the transaction, along with the amounts. In another embodiment, the first ledger may be automatically determined based on the type of journal entry made. For example, one system may automatically generate journal entries from scanned invoices or other documents. The computer system may determine the first amount and the first ledger to which it corresponds based on information read from the source document. Thus, if a source document contains the name of the supplier, the first amount may be associated with a ledger corresponding to that supplier.

The method may also include receiving a start date (618). In one embodiment, the start date represents a date on which the beginning balance should be determined for displaying the projected balances. The start date may be entered manually by a user, or determined automatically by a computer system. In one embodiment, the start date is automatically determined to be the beginning of the current accountant period. In other embodiments, the start date may be the beginning of the current month, the date when the first ledger was last closed, the beginning of the current year, the date of the last posted transaction, and/or the like.

The method may additionally include receiving a beginning balance (619). In one embodiment, the beginning balance represents a balance of the first ledger on the start date. The beginning balance may also be referred to as an “opening” balance. The method may further include receiving an activity total (620). In one embodiment, the activity total may comprise a sum of journal entries posted to the first ledger between the start date and a current date. In another embodiment, the activity total may also comprise journal entries selected to be posted pending approval. The activity total may be presented as a single sum, or may be presented as a series of line items showing individual transactions.

The method may also include determining a projected balance (622). In one embodiment, the projected balance represents a combination of the beginning balance, the activity total, and the first amount. The combination may be created by calculating the arithmetic sum of these amounts. For example, if the first amount as a debit of $500, the beginning balance is a credit of $1000, and the activity total was a debit of $250, the projected balance could be a credit of $250. In other embodiments, different methods of calculating the balance may be used, and may include additional factors, such as encumbrances and other reserved values in the first ledger.

The method may additionally include displaying a projected balances portlet together with the journal portlet (624). In one embodiment, the projected balances portlet comprises the beginning balance, the activity total, the first amount, and the projected balance. Each of these values may be displayed in a format and labeled such that a user can easily determine how the first amount affects the projected balance. In another embodiment, additional information may be displayed in the projected balances portlet, such as an identifier of an account associated with the first ledger, the start date, an indication of the accounting period, and/or the currency for each value. Additionally, the projected balances portlet may display indications when the projected balance may be incorrect. For example, the projected balances portlet may display a color or other visual indication when the projected balance exceeds a threshold. Alternatively, the projected balances portlet may highlight transactions that deviate from expected value, according to business rules defined by an organization. For example, it may be expected that certain types of invoices that involve debits within a certain value range or using a certain currency are charged to a particular account. The projected balances portlet may display an indication when any of these factors are not within an expected range.

In one embodiment, the projected balances portlet is displayed in the same window as the journal portlet. This may allow a user to see in real-time an effect that posting the selected journal entries may have on their associated accounts. Typos that would normally go undetected, or errors in the source documents may become more apparent when viewed in the context of the accounts which they are posted. Thus, a user may select journal entries one after another and quickly view the effects that these journal entries have on their respective accounts. In another embodiment, the projected balances portlet may be displayed together with the journal portlet as a pop-up window, a modal window, or other form of indication displayed on a screen at the same time.

In existing systems, the process for viewing a journal entry and the process for posting a journal entry are separate. These two processes use different workflows in different systems. Therefore, prior to this disclosure, when a journal entry required approval prior to posting, it would first be sent through an approval workflow. If the journal entry was approved through the approval workflow, then the accountant who originally submitted the entry for approval would receive an indication that it had been approved. The accountant could then submit the journal entry for posting via a journal entry posting workflow. Often, these two processes were kept separate because they were parts of different software packages. The approval workflow was always a part of task management software, whereas the journal posting workflow was a part of an accounting software package. In some cases, these two processes used separate computer systems and relied on messages passed between the two computer systems.

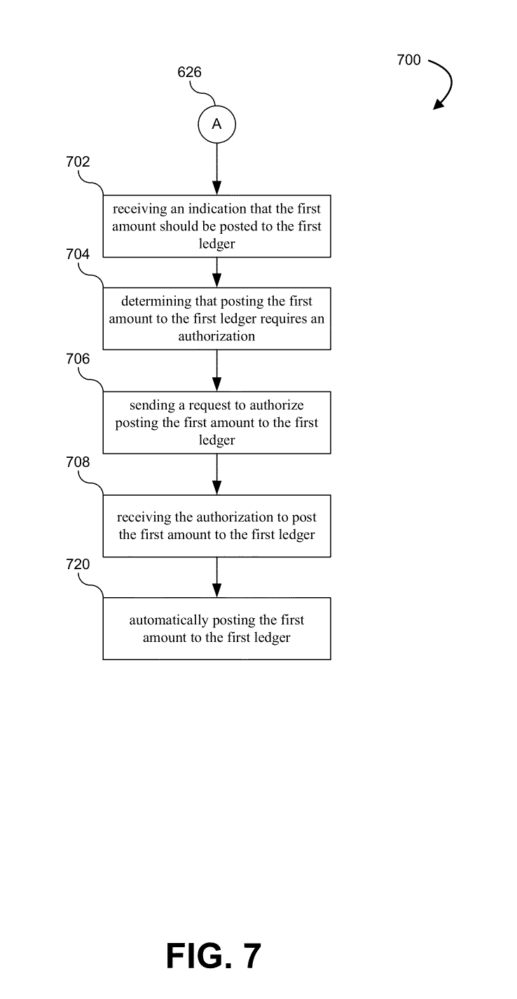

Embodiments disclosed herein combine these two processes, or workflows, into a single integrated process, or workflow. In one embodiment, the method in FIG. 6 may be extended to further include an automatic approval and posting process. FIG. 7 illustrates a flowchart 700 of a method for automatically posting a journal entry requiring review, according to one embodiment. The method may include receiving an indication that the first amount should be posted to the first ledger (702). This indication may be manually provided by an accountant by providing input to the journal portlet. This indication may also be automatically provided by the journal portlet according to predetermined criteria, such as surpassing a threshold number of days since the journal entry was made, having a total amount more or less than a threshold amount, or being associated with a certain account ledger.

The method may also include determining that posting the first amount to the first ledger requires an authorization (704). In one embodiment, this does not require entry into a separate workflow from the journal posting workflow. Instead, receiving an input to post a journal entry that requires approval automatically begins the steps necessary to acquire approval. In one embodiment, this process may be transparent to a user, such that no indication needs to be provided of the impending approval process. However, in another embodiment, an indication may be provided to a user that the journal posting may be temporarily delayed pending approval.

The method may additionally include sending a request to authorize posting the first amount to the first ledger (706). In embodiments where the approval workflow and the posting workflow are combined, a request originating in the journal portlet may be sent directly to a manager's workstation for approval. Alternatively, the request may be combined with requests in a batch for approval. In one embodiment, the same software system may provide interfaces for both the journal portlet and an approval portlet provided to a manager or other approving authority.

The method may further include receiving the authorization to post the first amount to the first ledger (708). In one embodiment, the authorization is based at least in part on the projected balance. In other words, an approval portlet provided to the approving authority may include a projected balance portlet similar to that which was provided when the journal entry was originally made. In one embodiment, the authorization may be received based on an automatic approval process. For instance, in cases where the projected balance represents a change below threshold percentage, the approving authority may authorize the approval portlet, and/or the computer system to automatically approve the journal entry posting.

The method may also include automatically posting the first amount to the first ledger in response to receiving the authorization (720). In one embodiment, as soon as authorization is received, the journal entry may automatically be posted. This process may be completely transparent to both the approving authority and the accountant who originally generated the journal entry. In another embodiment, the journal posting may still occur automatically, but an indication may also be sent to one or more of the approving authority and the accountant.

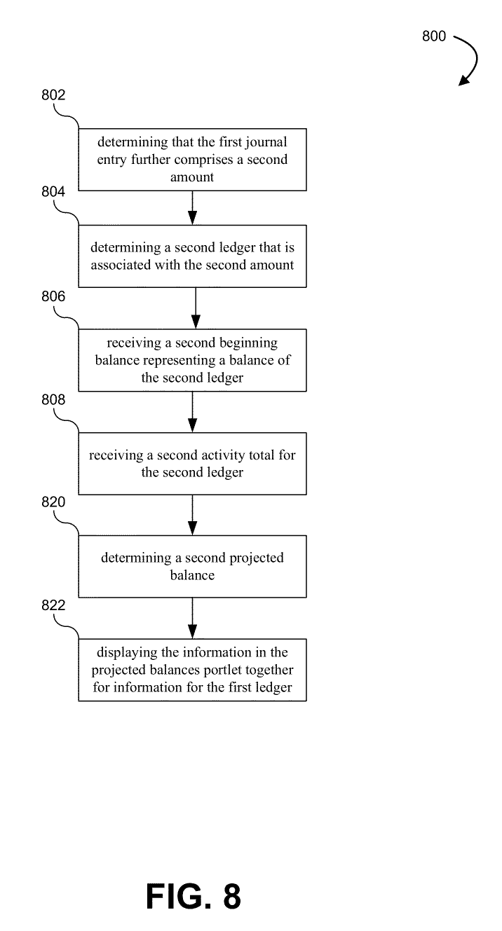

In many cases, the journal entry may comprise several transactions. Each transaction may include different amounts that are debited or credited to difference accounting ledgers or subledgers. FIG. 8 illustrates a flowchart 800 of a method for displaying the projected balances for multiple transactions in a single journal entry, according to one embodiment. The method may include determining that the first journal entry further comprises a second amount (802). Referring back to FIG. 3 as an example, journal entry 312 comprises two transactions, each of which is associated with a different account ledger. In one embodiment, a journal entry may comprise several transactions, and the second amount may be selected by selecting one of the several transactions. For example, the journal portlet may provide for user to select one or more transactions from a plurality of transactions within a journal entry. Although this method describes operations for a second amount, it will be understood in light of this disclosure that more than two amounts may be selected from one or more journal entries and analyzed one time.

The method may also include determining a second ledger that is associated with the second amount (804). In one embodiment, the second ledger is different from the first ledger, such that the first and second amounts are associated with different account ledgers. In another embodiment, the second ledger and the first ledger are the same, such that both the first and second amounts are associated with the same account ledger. This determination may be made using the same methods described in block 616 of FIG. 6.

The method may additionally include receiving a second beginning balance representing a balance of the second ledger (806). In one embodiment, the second balance represents the balance of the second ledger on the start date. The method may further include receiving a second activity total for the second ledger (808). In one embodiment, the second activity total may comprise a sum of journal entries posted to the second ledger between the start date and the current date. The method may also include determining a second projected balance for the second ledger (820). In one embodiment, the second projected balance may represent a combination of the second beginning balance, the second activity total, and the second amount. Note that blocks 806, 808, and 820 are similar to blocks 619, 620, and 622 of FIG. 6. Similar methods may be used to determine a projected balance for the second amount as were used to determine a projected balance for the first amount. In one embodiment, the second balance, the second activity total, and the second projected balance may be determined/received based on the start date received in block 618 of FIG. 6. In another embodiment, the second balance, the second activity total, and the second projected balance may be determined/received based on a different start date. This may occur when accounting periods are different for the first ledger and the second ledger.

The method may additionally include displaying the projected balance information for the first ledger and the projected balance information from the second ledger together in the projected balances portlet (822). In one embodiment, the projected balance information may include an identifier of the first ledger and an identifier of the second ledger. The projected balance information may further include the second beginning balance and the first beginning balance, the second activity total and the first activity total, the first amount and the second amount, and the first projected balance and the second projected balance. The projected balance information for each ledger may be displayed together in the same window of the projected balances portlet, or the projected balance information for each ledger may be displayed separately in windows within the projected balances portlet.

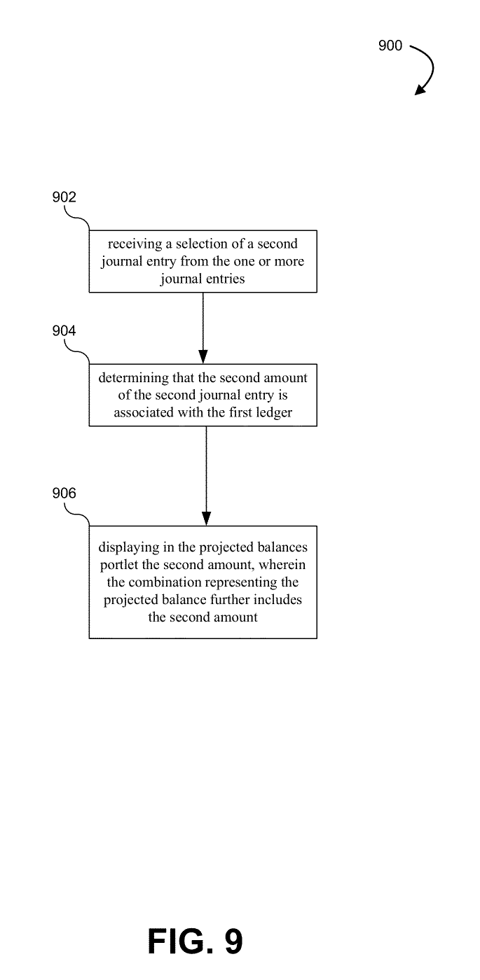

In addition to providing projected balances for different transactions within the same journal entry, some embodiments provide projected balances for different transactions within different journal entries. FIG. 9 illustrates a flowchart 900 of a method for displaying projected balances of transactions in different journal entries, according to one embodiment. The method may include receiving a selection of a second journal entry from the one or more journal entries (902). In one embodiment, the second journal entry comprises a second amount. In another embodiment, the second journal entry may be selected automatically based on the selection the first journal entry. For example, the first journal entry may be associated with the first account, and selecting the first journal entry may automatically select any other journal entries in the journal portlet that are also associated with the first account. This may also apply to individual transactions within separate journal entries. In yet another embodiment, either the first or second journal entry may comprise multiple amounts in addition to the first and second amounts. In other words, each journal entry may include multiple individual transactions. Therefore, it will be understood in light of this disclosure that the method of flowchart 900 may be extended to cover any number of transactions in separate journal entries.

The method may also include determining that the second amount of the second journal entry is associated with the first ledger (904). In this case, the two journal entries include transactions that debit or credit amounts to the same account ledger. Therefore, it may be beneficial to display the effect that both journal entries would have on the projected balance of a single account ledger.

The method may additionally include displaying, in the projected balances portlet, the second amount (906). In one embodiment, the combination of the beginning balance, the activity total, and the first amount representing the projected balance further includes the second amount. In other words, the projected balance may begin with the beginning balance of the first account, add the activity total, and then add the first and second amounts to calculate the projected balance for the first account ledger. The projected balances portlet may display the first amount and the second amount individually, or alternatively, the first and second amount may be combined into a single amount representing the transaction total from the selected journal entries.

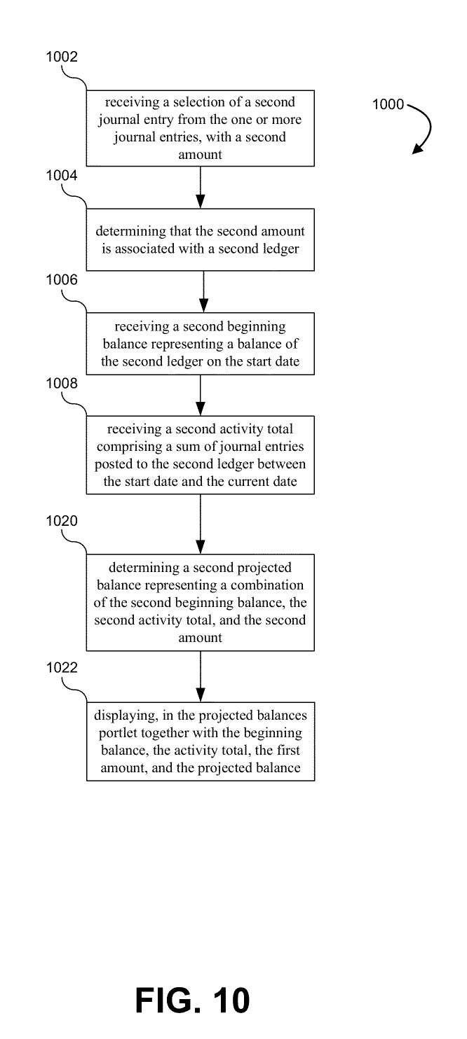

FIG. 10 illustrates a flowchart 1000 of a method for displaying projected balances of transactions in different journal entries that are associated with different account ledgers, according to one embodiment. The method of flowchart 1000 may be a continuation of the method of flowchart 600 in FIG. 6. The method may include receiving a selection of a second journal entry from the one or more journal entries (1002). In one embodiment, the second journal entry comprises a second amount. In one embodiment, a user may select one or more journal entries from the journal portlet. Each journal entry may be comprised of one or more transactions and/or amounts. For example, a first journal entry may be selected with transactions corresponding to the first account in the second account, while a second journal entry may be selected with transactions associated with a second account and a third account. It will be understood in light of this disclosure that any combination of selected journal entries may be used, each having one or more transactions.

The method may also include determining that the second amount is associated with a second ledger (1004). As explained above, second amounts may be associated with the second ledger for a number of different methods. The method may additionally include receiving a second beginning balance, representing a balance of the second ledger on the start date (1006). The method may further include receiving a second activity total comprising a sum of journal entries posted to the second ledger between the start date and the current date (1008). The method may also include determining a second projected balance representing a combination of the second beginning balance, the second activity total, and the second amount (1020). The method may additionally include displaying information associated with the second projected balance in the projected balances portlet together with the beginning balance, the activity total, the first amount, and the projected balance (1022). In one embodiment, the information associated with the second projected balance may comprise an identifier of the first ledger, an identifier of the second ledger, the second beginning balance, the second activity total, the second amount, and the second projected balance. Note that blocks 1004, 1006, 1008, 1020, and 1022 are similar to blocks 804, 806, 808, 820, and 822 of FIG. 8. In this case, a difference may be the source of the second amount. In FIG. 8, the second amount comes from a second transaction within a single journal entry, whereas in FIG. 10 the second amount comes from a transaction within a second journal entry.

It should be appreciated that the specific steps illustrated in FIG. 6 through FIG. 10 provide particular methods of validating an authorizing account balances according to embodiments of the present invention. Other sequences of steps may also be performed according to alternative embodiments. For example, alternative embodiments of the present invention may perform the steps outlined above in a different order. Moreover, the individual steps illustrated in FIG. 6 through FIG. 10 may include multiple sub-steps that may be performed in various sequences as appropriate to the individual step. Furthermore, additional steps may be added or removed depending on the particular applications. One of ordinary skill in the art would recognize many variations, modifications, and alternatives.

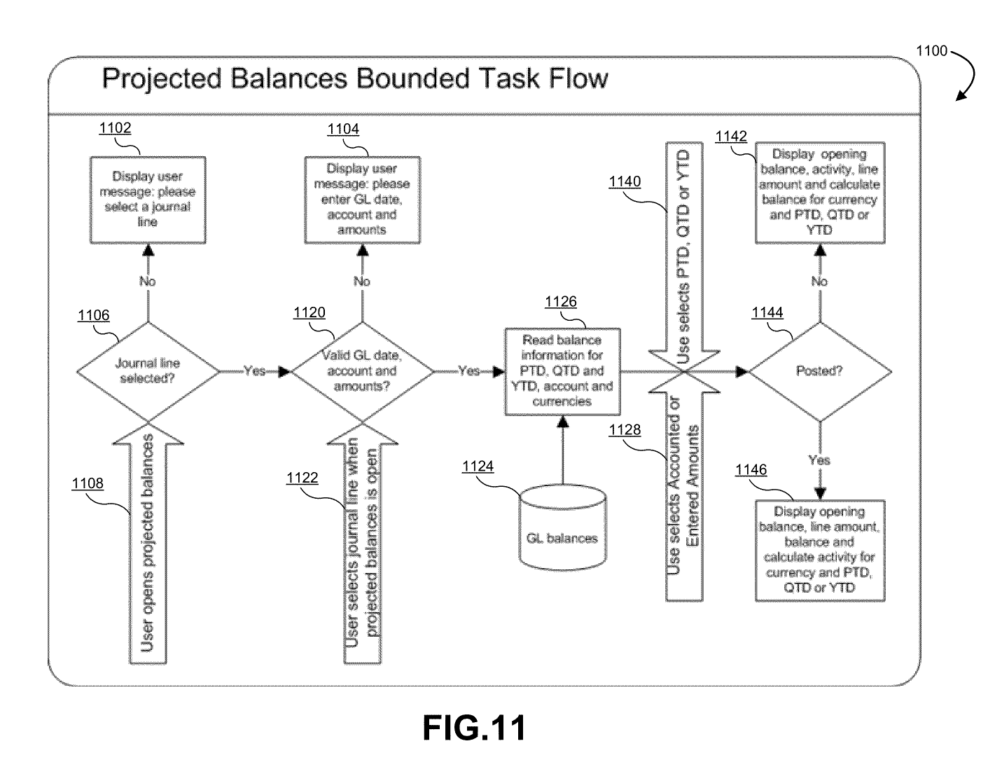

FIG. 11 illustrates a task flow 1100 for using a projected balance portlet to verify a journal entry, according to one embodiment. Task flow 1100 utilizes a specific piece of software, and it will be understood that the specific steps used herein are not meant to be limiting. A user may open the projected balances portlet (1108). It may then be determined whether a journal line is selected (1106). If a journal line has not been selected, then a message may be displayed to the user instructing the user to select a journal line (1102). If a journal line has been selected, then it may be determined whether a valid start date and account can be associated with the journal line (1120).

Alternatively, the user may select a journal line when the projected balance portlet is already open (1122). In another embodiment, the portlet need not be open, but rather a software process controlling the projected balance portlet may be operating in the background. When a user selects a journal line the projected balance portlet may automatically be opened, and the start date and accounts may be verified that point. If an account and/or start date cannot be verified, a message may be displayed to the user instructing the user to enter a valid start date and/or an account to associate with the transactions (1104). If these values can be validated, the balance information for the relevant accounting period may be read in to the projected balance portlet (1126). These values may be read from the general ledger database 1124, or from a multidimensional database that keeps aggregated totals in memory.

The user may also select between accounted or entered amounts to be used in the analysis (1128). If multiple balances are loaded, the user may also select between multiple accounting periods, such as period-to-date, quarter-to-date, or year-to-date (1140). It may then be determined whether journal entries have been posted during the relevant accounting period (1144). If they have been posted, the projected balance portlet may display the opening balance, the line amount, and the balance, and then calculate activity for the currency during the accounting period (1146). If they have not been posted, the projected balance portlet may display an opening balance, the activity since the beginning of the accounting period, and the line amount, and then calculate the balance for the currency and the accounting period to date.

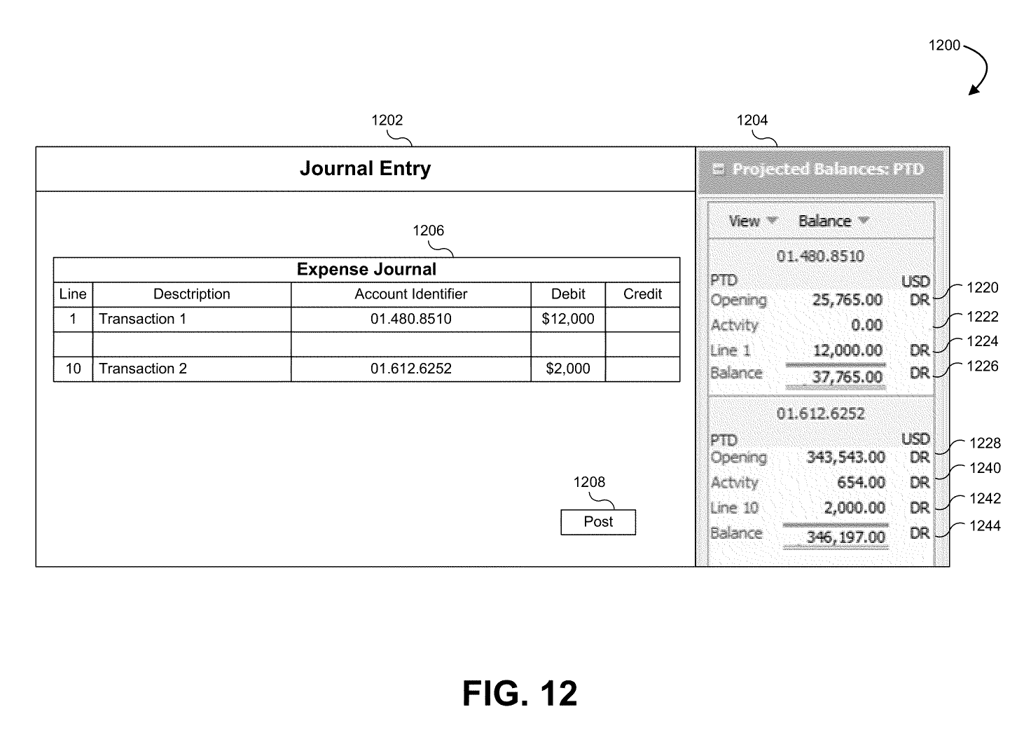

FIG. 12 illustrates an interface 1200 for displaying projected balances, according to one embodiment. Interface 1200 includes a journal portlet 1202. The journal portlet 1202 further includes a journal entry area comprised of an expense journal 1206. The expense journal 1206 may be used to enter expenses into an accounting system. The expense journal 1206 includes two transactions. Other transactions may also be included in the expense journal 1206, but they are omitted here for clarity and brevity.

Interface 1200 also includes a projected balances portlet 1204. The projected balances portlet includes a projected balance for each of the two accounts referenced by the two journal entries in the journal portlet 1202. In this example, account 01.480.8510 is shown in the top half of the projected balances portlet 1204. Also displayed is the opening balance of a debit of $25,765 (1220), $0.00 of activity since the beginning of the accounting period (1222), a debit of $12,000 (1224) from the first transaction of “Line 1” in the expense journal 1206, and the resulting projected balance of a debit of $37,765 (1226) in the account if “Line 1” were to be posted. The relevant accounting period is also shown as “PTD” (period-to-date) along with the currency, which is “USD”. In one embodiment, currencies may be normalized and/or converted within the projected balances portlet 1204. For example, the transaction entered into the journal portlet 1202 may use a different currency than what is displayed in the projected balances portlet 1204. The projected balances portlet 1204 may then convert the transaction in the differing currency into the currency of the account displayed in the projected balances portlet 1204.

The projected balances portlet 1204 also shows a projected balance for account number 01.612.6252 in the lower half of the window. This account is associated with “Line 10” in the expense journal 1206. It displays an opening balance of a debit of $343,543.00 (1228), an activity of a debit $654.00 (1240) since the beginning of the accounting period, a debit of $2000.00 (1242) from “Line 10” of the expense journal 1206, and a projected balance of a debit of $346,197.00 (1244) if the journal entry were to be posted.

In this example, the journal entries corresponding to Line 1 and Line 10 could be selected from a plurality of entries within the expense journal 1206. In another embodiment, multiple journals can be displayed within the journal portlet 1202 at the same time. Journal entries could be selected from different journals, and have their projected balances displayed in the projected balances portlet 1204. In one embodiment, the user must select journal entries to be displayed in the projected balances portlet 1204, while in another embodiment any journal entries entered into the journal portlet 1202 may have their projected balances displayed in the projected balances portlet 1204.

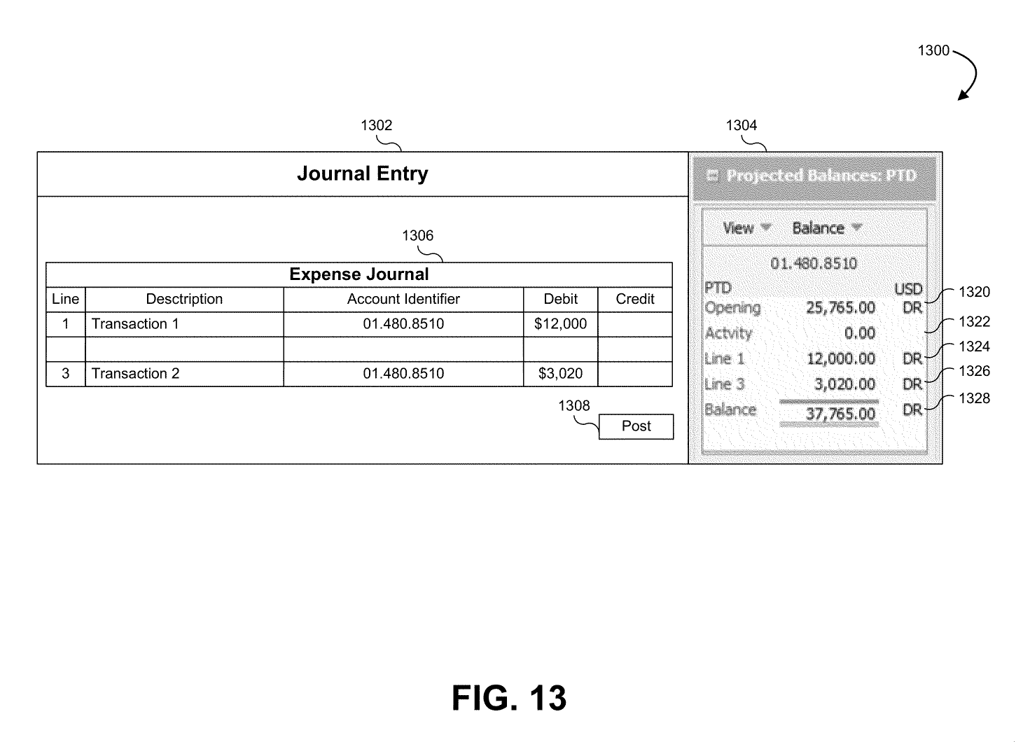

FIG. 13 illustrates an interface 1300 and displaying projected balances, according to another embodiment. Interface 1300 illustrates two journal entries in an expense journal 1306 on line 1 and line 3 that are associated with the same account, namely account number 01.480.8510. The projected balances portlet 1304 illustrates a projected balance for this single account while showing the effects of both line 1 and line 3. Thus, the projected balance of a debit of $37,765.00 for this account is calculated using a debit of $12,000.00 from line 1 and the debit of $3,020.00 from line 3. Although in this embodiment two different journal entries from the same expense journal 1306 and been selected, the same type of displayed may also apply to journal entries selected from different journals and/or transactions selected from within journal entries, so long as they pertain to the same account. In another embodiment, interface 1300 may be combined with interface 1200 from FIG. 12. Therefore, multiple transactions may be displayed for multiple accounts within the projected balances portlet 1304.

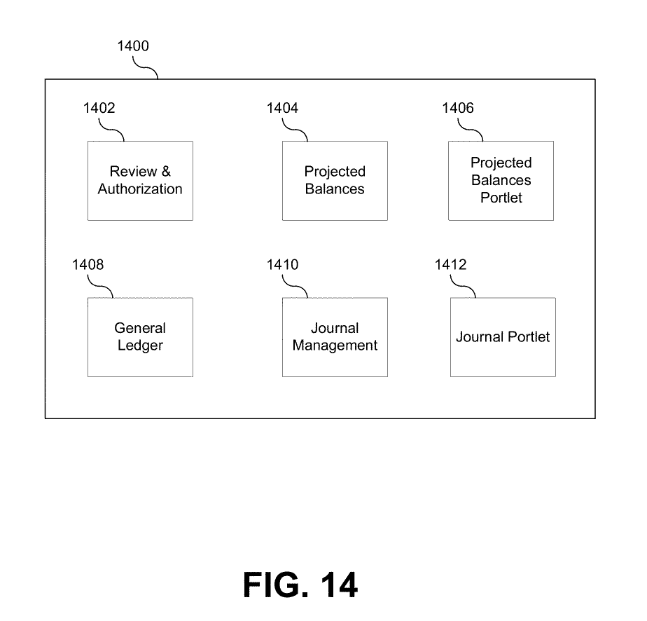

FIG. 14 illustrates a block diagram of an exemplary system for implementing a journal entry and preview interface 1400, according to one embodiment. The journal entry and preview interface 1400 may include a journal management module 1410 configured to manage, record, edit, post, validate, and/or store journal entries. The journal entry and preview interface 1400 may also include a journal portlet 1412 for viewing journal entries from the journal management module 1410. Similarly, the journal entry and preview interface 1400 may include a projected balances module 1404 for calculating and validating projected balances of accounts associated with journal entries from the journal management module 1410. A projected balances portlet 1406 may also be provided to display projected balances from the projected balances module 1404.

A review and authorization module 1402 may be provided to review journal entries that are posted from the journal management module 1410. Review and authorization module 1402 may utilize both the projected balances module 1404 and the projected balances portlet 1406 during the review process. At the completion of the review process, a general ledger module 1408 may receive and post journal entries for final recording in a general ledger and/or subsidiary ledgers.

In one embodiment, the various modules in FIG. 14 may reside on separate computer systems. Alternatively, multiple modules may be combined on the same or similar computer systems. In addition, some modules may be combined together into a single module performing the functions of both individual modules. Similarly, a single module may be split into multiple modules. It will be understood in light of this disclosure that any arrangement of the modules, as well as any implementation in both software and hardware, may be used by various embodiments.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of previewing projected balance impacts in an Enterprise Financial Accounting System, the method comprising:
receiving, by a computer system, one or more journal entries that have not been posted to an accounting ledger;
displaying, by the computer system, the one or more journal entries in a journal portlet;
receiving, by a computer system, a selection of a first journal entry from the one or more journal entries, wherein the first journal entry comprises a first amount;
determining, by a computer system, a first ledger that is associated with the first amount;
receiving a start date;
receiving a beginning balance representing a balance of the first ledger on the start date;
receiving an activity total comprising a sum of journal entries posted to the first ledger between the start date and a current date;
determining, by a computer system, a projected balance representing a combination of the beginning balance, the activity total, and the first amount; and
displaying, by a computer system, a projected balances portlet together with the journal portlet, wherein the projected balances portlet comprises:
the beginning balance;
the activity total;
the first amount; and
the projected balance.

2. The method of claim 1, further comprising:
receiving an indication that the first amount should be posted to the first ledger;
determining that posting the first amount to the first ledger requires an authorization;
sending a request to authorize posting the first amount to the first ledger;
receiving the authorization to post the first amount to the first ledger, wherein the authorization is based at least in part on the projected balance; and
automatically posting the first amount to the first ledger in response to receiving the authorization.

3. The method of claim 2, further comprising displaying an indication to a user that posting the first amount to the first ledger requires the authorization.

4. The method of claim 2. wherein:
the request to authorize posting the first amount to the first ledger is part of a work flow; and
posting the first amount to the first ledger is part of the same workflow.

5. The method of claim 1, further comprising:
determining that the first journal entry further comprises a second amount;
determining a second ledger that is associated with the second amount;
receiving a second beginning balance representing a balance of the second ledger on the start date;
receiving a second activity total comprising a sum of journal entries posted to the second ledger between the start date and the current date;
determining a second projected balance representing a combination of the second beginning balance, the second activity total, and the second amount; and
displaying, in the projected balances portlet together with the beginning balance, the activity total, the first amount, and the projected balance:
an identifier of the first ledger;
an identifier of the second ledger;
the second beginning balance;
the second activity total;
the second amount; and
the second projected balance.

6. The method of claim 1, further comprising:
receiving a selection of a second journal entry from the one or more journal entries, wherein the second journal entry comprises a second amount;
determining that the second amount of the second journal entry is associated with the first ledger; and
displaying in the projected balances portlet the second amount, wherein the combination representing the projected balance further includes the second amount.

7. The method of claim 1, further comprising:
receiving a selection of a second journal entry from the one or more journal entries, wherein the second journal entry comprises a second amount;
determining that the second amount is associated with a second ledger;
receiving a second beginning balance representing a balance of the second ledger on the start date;
receiving a second activity total comprising a sum of journal entries posted to the second ledger between the start date and the current date;
determining a second projected balance representing a combination of the second beginning balance, the second activity total, and the second amount; and
displaying, in the projected balances portlet together with the beginning balance, the activity total, the first amount, and the projected balance:
an identifier of the first ledger;
an identifier of the second ledger;
the second beginning balance;
the second activity total;
the second amount; and
the second projected balance.

8. The method of claim 1, wherein the start date is the beginning of an accounting period.

9. The method of claim 1, wherein displaying the projected balances portlet occurs automatically in response to the selection of the first journal entry.

10. The method of claim 1, wherein the combination of the beginning balance, the activity total, and the first amount comprises an arithmetic sum of the beginning balance, the activity total, and the first amount.

11. The method of claim 1, wherein the first amount comprises a first currency and the second amount comprises a second currency, and wherein the projected balance portlet converts the first amount into the second currency.

12. A computer-readable memory having stored thereon a sequence of instructions which, when executed by one or more processors, causes the one or more processors to preview projected balance impacts in an Enterprise Financial Accounting System by:
receiving one or more journal entries that have not been posted to an accounting ledger;
displaying the one or more journal entries in a journal portlet;
receiving a selection of a first journal entry from the one or more journal entries, wherein the first journal entry comprises a first amount;
determining a first ledger that is associated with the first amount;
receiving a start date;
receiving a beginning balance representing a balance of the first ledger on the start date;
receiving an activity total comprising a sum of journal entries posted to the first ledger between the start date and a current date;
determining a projected balance representing a combination of the beginning balance, the activity total, and the first amount; and
displaying a projected balances portlet together with the journal portlet, wherein the projected balances portlet comprises:
the first amount; and
the projected balance.

13. The computer-readable memory according to claim 12, wherein the instructions further cause the one or more processors to preview projected balance impacts in an Enterprise Financial Accounting System by:
receiving an indication that the first amount should be posted to the first ledger;
determining that posting the first amount to the first ledger requires an authorization;
sending a request to authorize posting the first amount to the first ledger;
receiving the authorization to post the first amount to the first ledger, wherein the authorization is based at least in part on the projected balance; and
automatically posting the first amount to the first ledger in response to receiving the authorization.

14. The computer-readable memory according to claim 12, wherein the instructions further cause the one or more processors to preview projected balance impacts in an Enterprise Financial Accounting System by:
determining that the first journal entry further comprises a second amount;
determining a second ledger that is associated with the second amount;
receiving a second beginning balance representing a balance of the second ledger on the start date;
receiving a second activity total comprising a sum of journal entries posted to the second ledger between the start date and the current date;
determining a second projected balance representing a combination of the second beginning balance, the second activity total, and the second amount; and
displaying, in the projected balances portlet together with the beginning balance, the activity total, the first amount, and the projected balance:
the second amount; and
the second projected balance.

15. The computer-readable memory according to claim 12, wherein the instructions further cause the one or more processors to preview projected balance impacts in an Enterprise Financial Accounting System by:
receiving a selection of a second journal entry from the one or more journal entries, wherein the second journal entry comprises a second amount;
determining that the second amount of the second journal entry is associated with the first ledger;
displaying in the projected balances portlet the second amount, wherein the combination representing the projected balance further includes the second amount.

16. The computer-readable memory according to claim 12, wherein
the request to authorize posting the first amount to the first ledger is part of a work flow; and
posting the first amount to the first ledger is part of the same workflow.

17. A system comprising:
one or more processors; and
a memory communicatively coupled with and readable by the one or more processors and having stored therein a sequence of instructions which, when executed by the one or more processors, cause the one or more processors to preview projected balance impacts in an Enterprise Financial Accounting System by:
receiving one or more journal entries that have not been posted to an accounting ledger;
displaying the one or more journal entries in a journal portlet;
receiving a selection of a first journal entry from the one or more journal entries, wherein the first journal entry comprises a first amount;
determining a first ledger that is associated with the first amount;
receiving a start date;
receiving a beginning balance representing a balance of the first ledger on the start date;
receiving an activity total comprising a sum of journal entries posted to the first ledger between the start date and a current date;
determining a projected balance representing a combination of the beginning balance, the activity total, and the first amount; and
displaying a projected balances portlet together with the journal portlet, wherein the projected balances portlet comprises:
the first amount; and
the projected balance.

18. The system of claim 17 wherein the instructions further cause the one or more processors to preview projected balance impacts in an Enterprise Financial Accounting System by:
receiving a selection of a second journal entry from the one or more journal entries, wherein the second journal entry comprises a second amount;
determining that the second amount is associated with a second ledger;
receiving a second beginning balance representing a balance of the second ledger on the start date;
receiving a second activity total comprising a sum of journal entries posted to the second ledger between the start date and the current date;
determining a second projected balance representing a combination of the second beginning balance, the second activity total, and the second amount; and
displaying, in the projected balances portlet together with the beginning balance, the activity total, the first amount, and the projected balance:
an identifier of the first ledger;
an identifier of the second ledger;
the second beginning balance;
the second amount; and
the second projected balance.

19. The system of claim 17 wherein displaying the projected balances portlet occurs automatically in response to the selection of the first journal entry.

20. The system of claim 17 wherein the first amount comprises a first currency and the second amount comprises a second currency, and wherein the projected balance portlet converts the first amount into the second currency.
